(19) United States
(12) Patent Application Publication
(10) Pub. No.: US 2023/0054283 A1
(43) Pub. Date: Feb. 23, 2023

(54) METHODS AND APPARATUSES FOR GENERATING STYLE PICTURES

(71) Applicant: KWAI INC., Palo Alto, CA (US)

(72) Inventors: Jiayi LIU, Fremont, CA (US); Shen WANG, Beijing (CN); Zhenyu LIAO, Mountain View, CA (US); Huayan WANG, Palo Alto, CA (US)

(73) Assignee: KWAI INC., Palo Alto, CA (US)

(21) Appl. No.: 17/408,107

(22) Filed: Aug. 20, 2021

(51) Int. Cl. G06T 11/00; G06K 9/00; G06K 9/62; G06T 5/50; G06N 3/08

(52) U.S. Cl. CPC G06T 11/00; G06K 9/00228; G06K 9/6217; G06T 5/50; G06N 3/088; G06T 2207/20221; G06T 2207/20084; G06T 2207/20081; G06T 2207/30201

(57) ABSTRACT

A style picture generating method, an apparatus and a non-transitory computer readable storage medium thereof are provided. The method includes: obtaining one or more models by training a neural network; obtaining a plurality of interpolated models based on the one or more models; generating a plurality of pictures by the plurality of interpolated models; and generating the style picture by combining two or more pictures in the plurality of pictures using one or more model-specific alpha masks.

### FIELD

The present application relates to generating style pictures, and in particular but not limited to, generating style pictures based on multiple models using neural networks.

### BACKGROUND

Some neural networks, for example, style-based generative neural networks (StyleGANs), provide an adversarial generative modeling framework, which shows a powerful generation ability in learning structures of human faces and drawing virtual human faces. Further, technologies including StyleGAN blending technology can generate paired virtual human photos and stylized images, which have stylized special effects, while maintaining the identity of the face. Moreover, the generated paired data facilitate further training of a downstream deep network model to convert user's input photos into maps with stylized special effects.

The existing StyleGAN blending technology first trains a StyleGAN model, i.e., a base model, using a face dataset, such as Flickr-Faces-HQ (FFHQ), to generate a series of realistic face images. Then, a batch of face special effects pictures with specific styles are selected to further train and optimize the base model and obtain a new model, i.e., a transferred model, that can generate special effects. However, the base model and the transferred model cannot guarantee good consistency of facial identity features. As a result, the two models cannot create a personalized style image or provide matching data for downstream models.

Furthermore, the StyleGAN blending technology interpolates weights of different layers in the two models, i.e., the base model and the transferred model, to obtain a new model, i.e., an interpolated model. The interpolated model can balance identity characteristics generated by the base model and maintain style characteristics of the transferred model. A balance between the identity characteristics and the style characteristics can be obtained by adjusting interpolation strategies in different layers.

The existing StyleGAN blending technology relies on a large amount of uniformly styled data to train the transferred model. However, it is hard to guarantee pictures or data with a uniform style. Works created by artists are often expensive, with few samples, and the styles are not completely consistent. The incompetence of these pictures or data causes the transferred model's failure in converging to a high-quality style effect. Furthermore, it is hard to guarantee the quality of the generated images from the final interpolated model. As a result, it is difficult to pass the aesthetic requirements of the business side.

Moreover, when there is a need to mix different styles of works to create a new style, the existing technology cannot controllably blend the style effects of different models, such as hair feature of one style and facial features of another style.

### SUMMARY

The present disclosure provides examples of techniques relating to generating one or more style pictures by mixing generation effects of different interpolated models in different regions without adding additional data for training downstream models.

According to a first aspect of the present disclosure, there is provided a method for generating a style picture. The method may include obtaining one or more models by training a neural network.

Further, the method may include obtaining a plurality of interpolated models based on the one or more models, generating a plurality of pictures by the plurality of interpolated models, and generating the style picture by combining two or more pictures in the plurality of pictures using one or more model-specific alpha masks.

According to a second aspect of the present disclosure, there is provided an apparatus for generating a style picture. The apparatus may include one or more processors and a memory configured to store instructions executable by the one or more processors. The one or more processors, upon execution of the instructions, are configured to obtain one or more models by training a neural network.

Further, the one or more processors may be configured to obtain a plurality of interpolated models based on the one or more models, generate a plurality of pictures by the plurality of interpolated models, and generate the style picture by combining two or more pictures in the plurality of pictures using one or more model-specific alpha masks.

According to a third aspect of present disclosure, there is provided a non-transitory computer readable storage medium including instructions stored therein. Upon execution of the instructions by one or more processors, the instructions may cause the one or more processors to perform acts including obtaining one or more models by training a neural network.

Further, the instructions may cause the one or more processors to perform acts including obtaining a plurality of interpolated models based on the one or more models, generating a plurality of pictures by the plurality of interpolated models, and generating the style picture by combining two or more pictures in the plurality of pictures using one or more model-specific alpha masks.

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1 illustrates three different models including a base model, a transferred model, and an interpolated model in accordance with some implementations of the present disclosure.

FIG. 2A illustrates a picture generated by a base model in accordance with some implementations of the present disclosure.

FIG. 2B illustrates a first picture generated by a first interpolated model in accordance with some implementations of the present disclosure.

FIG. 2C illustrates a second picture generated by a second interpolated model in accordance with some implementations of the present disclosure.

FIG. 2D illustrates a facial picture with different facial regions identified in accordance with some implementations of the present disclosure.

FIG. 3 illustrates a style picture generated based on the first picture and the second picture in accordance with some implementations of the present disclosure.

FIG. 4 is a block diagram illustrating a system for generating a style picture in accordance with some implementations of the present disclosure.

FIG. 5 is a flowchart illustrating an exemplary process of generating a style picture in accordance with some implementations of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” and etc. are all used as nomenclature only for references to relevant elements, e.g., devices, components, compositions, steps, and etc., without implying any spatial or chronological orders, unless expressly specified otherwise. For example, a “first device” and a “second device” may refer to two separately formed devices, or two parts, components or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may comprise steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

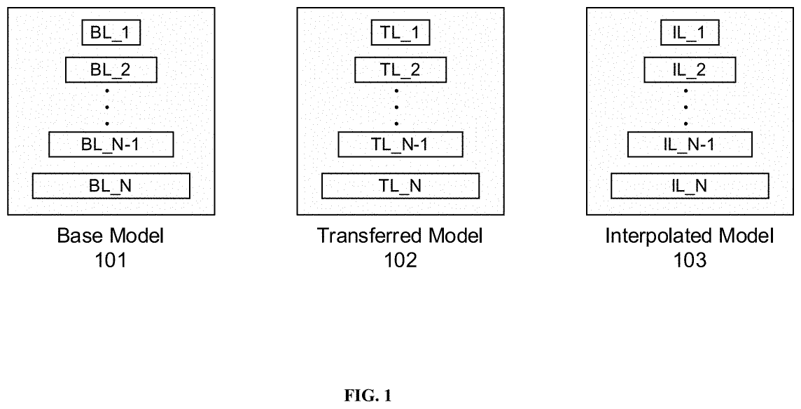

FIG. 1 illustrates three different models including a base model, a transferred model, and an interpolated model in accordance with some implementations of the present disclosure. The base model 101, as illustrated in FIG. 1, may be generated by training a neural network using a face dataset. The face dataset may include a dataset of human faces, such as Flickr-Faces-HQ (FFHQ) consisting of 70,000 high-quality images at 1024² resolutions. In some examples, the base model may be generated by training the face dataset using a StyleGAN and the base model may generate a series of realistic face images after training the face dataset.

In some examples, the base model 101 may include a plurality of resolution layers, BL_1, BL_2, . . . , BL_N-1, and BL_N, that are responsible for different features in the generated pictures, where N is a positive integer that is greater than 1. The plurality of resolution layers, BL_1, BL_2, . . . , BL_N-1, and BL_N, are respectively corresponding to different resolutions. The resolution of the resolution layer BL_i may be respectively higher than the resolution of the resolution layer BL_i-1, where i is a positive integer between 2 and N. The resolution layer BL_1 may be corresponding to the lowest resolution while the resolution layer BL_N may be corresponding to the highest resolution.

In some examples, in the base model 101, the resolution layer BL_1 may be corresponding to a resolution of 4×4, and the resolution layer BL_2 may be corresponding to a resolution of 8×8. Moreover, the resolution layer BL_N-1 may be corresponding to a resolution of 512×512, and the resolution layer BL_N may be corresponding to a resolution of 1024×1024.

As illustrated in FIG. 1, a transferred model 102 may be generated by training the base model 101 on one or more new datasets. In some examples, different transferred models may be generated by training the base model 101 on multiple datasets which are respectively related to different styles.

In some other examples, different transferred models may be generated in different training periods when the dataset of one style is used for training the base model 101.

The transferred model 102 may include a plurality of resolution layers, TL_1, TL_2, . . . , TL_N-1, and TL_N, as illustrated in FIG. 1. N is a positive integer that is greater than 1. The plurality of resolution layers, TL_1, TL_2, . . . , TL_N-1, and TL_N, are respectively corresponding to different resolutions. The resolution of the resolution layer TL_i may be respectively higher than the resolution of the resolution layer TL_i-1, where i is a positive integer between 2 and N. The resolution layer TL_1 may be corresponding to the lowest resolution while the resolution layer TL_N may be corresponding to the highest resolution. Different resolution layers are responsible for different features in the generated pictures.

In some examples, in the transferred model 102, the resolution layer TL_1 may be corresponding to a resolution of 4×4, and the resolution layer TL_2 may be corresponding to a resolution of 8×8. Moreover, the resolution layer TL_N-1 may be corresponding to a resolution of 512×512, and the resolution layer TL_N may be corresponding to a resolution of 1024×1024.

Further, a plurality of interpolated models may be generated based on one or more models obtained by training the neural network. The one or more models may include the base model 101, the transferred model 102, or any model obtained by training the neural network. The one or more models may have same architecture.

In some examples, the plurality of interpolated models may be generated through interpolating at the different resolution layers in the base model 101.

In some examples, the plurality of interpolated models may be respectively generated by interpolating at different resolution layers of the transferred model 102. In some examples, through interpolating at the different resolution layers in the transferred model 102 and the base model 101, multiple different interpolated models may be generated.

FIG. 1 illustrates an example of an interpolated model 103.The interpolated model 103 includes a plurality of resolution layers, IL_1, IL_2, . . . , IL_N-1, and IL_N, as illustrated in FIG. 1. N is a positive integer that is greater than 1. The plurality of resolution layers, IL_1, IL_2, . . . , IL_N-1, and IL_N, are respectively corresponding to different resolutions. The resolution of the resolution layer IL_i may be respectively higher than the resolution of the resolution layer IL_i-1, where i is a positive integer between 2 and N. The resolution layer IL_1 may be corresponding to the lowest resolution while the resolution layer IL_N may be corresponding to the highest resolution. Different resolution layers are responsible for different features in the generated pictures.

In some examples, in the interpolated model 103, the resolution layer IL_1 may be corresponding to a resolution of 4×4, and the resolution layer IL_2 may be corresponding to a resolution of 8×8. Moreover, the resolution layer IL_N-1 may be corresponding to a resolution of 512×512, and the resolution layer IL_N may be corresponding to a resolution of 1024×1024.

In some examples, a plurality of different interpolated models may be further generated based on the interpolated model 103. For example, the plurality of different interpolated models may be generated by respectively interpolating different resolution layers of the interpolated model 103.

In some examples, the plurality of different interpolated models may include a first interpolated model, a second interpolated model, a third interpolated model. Due to data limitations, a single model may have some specific flaws, artifacts, or areas that do not meet business needs or requirements. Moreover, these problems are coupled with feature parts of the face. If the generation effect of eyes is flawed, the model has problems with eyes in most of the generated images. As a result, there is a possibility of replacing results of other models as a whole.

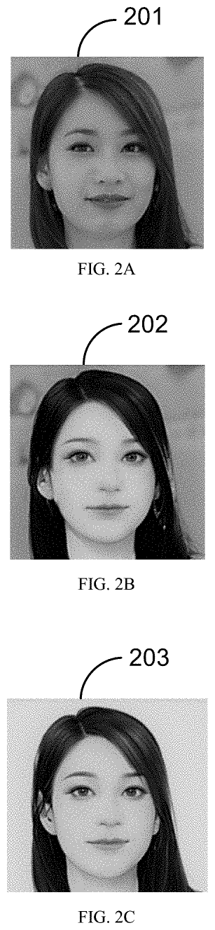

FIG. 2A illustrates a picture 201 generated by a base model in accordance with some implementations of the present disclosure. FIG. 2B illustrates a first picture 202 generated by a first interpolated model in accordance with some implementations of the present disclosure. FIG. 2C illustrates a second picture 203 generated by a second interpolated model in accordance with some implementations of the present disclosure.

The picture 201 shown in FIG. 2A is a fake human face photo that is generated by the base model as illustrated in FIG. 1. In some examples, the picture 201 shown in FIG. 2A is a generated photo for illustration, which is not a real-person photo. The first picture 202 as shown in FIG. 2B is a style picture generated by the first interpolated model. As shown in FIG. 2B, the first picture 202 may meet all requirements except hair with flaws or artifacts. The second picture 203 as shown in FIG. 2C is a style picture generated by the second interpolated model. As shown in FIG. 2C, the second picture 203 has no flaw or artifacts in hair but the skin tone does not meet the business requirements.

In some examples, most of pictures or all pictures generated by one interpolated model may have the same artifact or flaw. For example, most of pictures or all pictures generated by the first interpolated model may have the same artifact with the hair as the first picture 202, and most of pictures or all pictures generated by the second interpolated model may have the same artifact with the skin tone as the second picture 203.

In some examples, after obtaining the first picture 202 and the second picture 203, a face analysis model is used to identify a target area or region in the two pictures. For example, the face analysis model identifies hair regions of the two pictures, and replace the hair region of the first picture 202 with the hair region of the second picture 203 to obtain a style picture with hair having no flaws or artifacts.

In some examples, image masking is used to implement the replacement of the target region in pictures. For example, a mask is used to replace the hair region of the first picture 202 with the hair region of the second picture 203.

In some examples, due to blunt transition area caused by the image masking, targeted adjustments, e.g., feathering, in different facial regions are used and the two pictures, i.e., the first picture 202 and the second picture 203, are combined by using a model-specific alpha mask.

FIG. 2D illustrates a facial picture with different facial regions identified in accordance with some implementations of the present disclosure. As shown in FIG. 2D, different facial regions in the picture 204 are identified. The different facial regions may include, but not limited to, hair region, nose region, ear region, mouth region, eye region, and face region. The picture 204 may be the first picture 202, the second picture 203, or any picture including flaws or artifacts needs to be combined.

In some examples, the different facial regions may be identified by using an intermediate matrix M_{face}. Taking the hair region as an example, the hair region of the first picture 202 or the second picture 203 is identified by determining an intermediate matrix M_{face} corresponding to the hair region. The intermediate matrix M_{face} may include a plurality of matrix elements m_{face}, where the matrix elements m_{face} equal to 0 denote that these elements indicate the background of the picture, and the matrix elements of m_{face} equal to 1 denotes that these matrix elements indicate the facial target region in the picture, e.g., the hair region.

After a facial target region, e.g., one of the different facial regions, is identified, an alpha mask matrix Mₐₗₚₕₐ is obtained by performing convolution operations on the intermediate matrix M_{face} using a kernel function. The kernel function may be a two-dimensional Gaussian function for feature shapes. In some examples, the two-dimensional alpha mask matrix Mₐₗₚₕₐ is obtained by using following equation (1):

Mₐₗₚₕₐ(x,y)=∫∫_{a,b}K(a,b)M_{face}(x−a, y−b)dadb (1)

where K (a, b) denotes the two-dimensional Gaussian function, M_{face}(x−a, y−b) denotes the intermediate matrix. The model-specific alpha mask may be implemented by the equation (1).

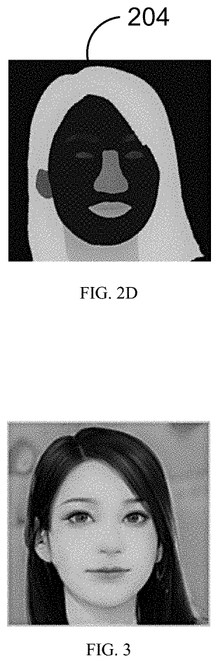

FIG. 3 illustrates a style picture generated based on the first picture and the second picture in accordance with some implementations of the present disclosure. Based on the alpha mask matrix Mₐₗₚₕₐ obtained above, a combined style picture is generated by combining the first picture and the second picture. In some examples, the style picture may be obtained by using following equation (2):

I_{final}=(1−Mₐₗₚₕₐ)I_{first}+MₐₗₚₕₐI _{second} (2)

where I_{final} denotes the style picture, I_{first} denotes the first picture 202 generated by the first interpolated model, I_{second} denotes the second picture 203 generated by the second interpolated model, and Mₐₗₚₕₐ denotes the two-dimensional alpha mask matrix.

As shown in FIG. 3, the style picture generated by combining the first picture and the second picture using the equation (2) alleviates the hair flaw in the first picture 202 and the skin tone flaw in the second picture 203, as shown in FIGS. 2B and 2C. Further, the transition between the first picture and the second picture is natural, without a sense of rigid splicing.

Moreover, a style picture may be obtained by combining multiple pictures that are respectively generated by multiple different interpolated models. For example, in addition to the first picture 202 and the second picture 203, a third picture is generated by a third interpolated model that is different from the first and second interpolated models. After a first combined picture, i.e., the style picture generated in FIG. 3, is obtained by combining the first picture 202 and the second picture 203 using a first model-specific alpha mask, a final style picture is then obtained by combining the first combined picture and the third picture by using a second model-specific alpha mask. The first model-specific alpha mask may be the same as or different from the second model-specific alpha mask.

In some examples, the first combined picture that is obtained by combining the first picture 202 and the second picture 203 may still have artifacts or flaws in the face or in other facial regions, such as the nose region, the ear region, etc. For example, the first combined picture has flaws in the nose region, and the third picture generated by the third interpolated model has no flaw in the nose region. To further improve the effect of generating style pictures, the first combined picture and the third picture are combined by using the second model-specific alpha mask.

The examples in the present disclosure integrate different stylized features to create new style special effects by combining styles, thereby reducing cost of manual drawing and retouching. When there are flaws or artifacts with the multiple different models, flaws or artifacts of a single model may be eliminated by combining advantages of the multiple different models. Thus, manual editing in later stages are avoided. When style data is difficult to cover various situations, for examples, wearing glasses, regions with good effects generated by the existing models are used to replace areas in pictures generated by models with missing data or with bad effect, thus aesthetic style pictures may be generated.

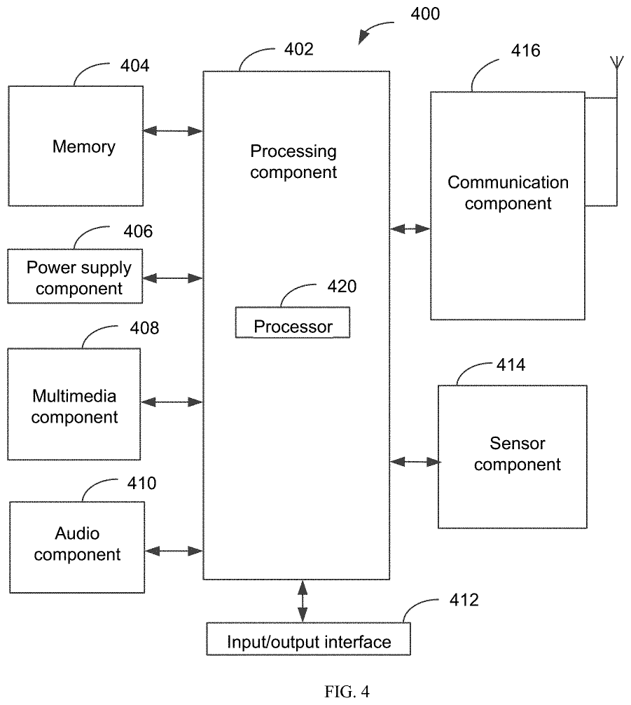

FIG. 4 is a block diagram illustrating an image processing system in accordance with some implementations of the present disclosure. The system 400 may be a terminal, such as a mobile phone, a tablet computer, a digital broadcast terminal, a tablet device, or a personal digital assistant.

As shown in FIG. 4, the system 400 may include one or more of the following components: a processing component 402, a memory 404, a power supply component 406, a multimedia component 408, an audio component 410, an input/output (I/O) interface 412, a sensor component 414, and a communication component 416.

The processing component 402 usually controls overall operations of the system 400, such as operations relating to display, a telephone call, data communication, a camera operation and a recording operation. The processing component 402 may include one or more processors 420 for executing instructions to complete all or a part of steps of the above method. The processors 420 may include CPU, GPU, DSP, or other processors. Further, the processing component 402 may include one or more modules to facilitate interaction between the processing component 402 and other components. For example, the processing component 402 may include a multimedia module to facilitate the interaction between the multimedia component 408 and the processing component 402.

The memory 404 is configured to store different types of data to support operations of the system 400. Examples of such data include instructions, contact data, phonebook data, messages, pictures, videos, and so on for any application or method that operates on the system 400. The memory 404 may be implemented by any type of volatile or non-volatile storage devices or a combination thereof, and the memory 404 may be a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or a compact disk.

The power supply component 406 supplies power for different components of the system 400. The power supply component 406 may include a power supply management system, one or more power supplies, and other components associated with generating, managing and distributing power for the system 400.

The multimedia component 408 includes a screen providing an output interface between the system 400 and a user. In some examples, the screen may include a Liquid Crystal Display (LCD) and a Touch Panel (TP). If the screen includes a touch panel, the screen may be implemented as a touch screen receiving an input signal from a user. The touch panel may include one or more touch sensors for sensing a touch, a slide and a gesture on the touch panel. The touch sensor may not only sense a boundary of a touching or sliding actions, but also detect duration and pressure related to the touching or sliding operation. In some examples, the multimedia component 408 may include a front camera and/or a rear camera. When the system 400 is in an operation mode, such as a shooting mode or a video mode, the front camera and/or the rear camera may receive external multimedia data.

The I/O interface 412 provides an interface between the processing component 402 and a peripheral interface module. The above peripheral interface module may be a keyboard, a click wheel, a button, or the like. These buttons may include but not limited to, a home button, a volume button, a start button and a lock button.

The sensor component 414 includes one or more sensors for providing a state assessment in different aspects for the system 400. For example, the sensor component 414 may detect an on/off state of the system 400 and relative locations of components. For example, the components are a display and a keypad of the system 400. The sensor component 414 may also detect a position change of the system 400 or a component of the system 400, presence or absence of a contact of a user on the system 400, an orientation or acceleration/deceleration of the system 400, and a temperature change of system 400. The sensor component 414 may include a proximity sensor configured to detect presence of a nearby object without any physical touch. The sensor component 414 may further include an optical sensor, such as a CMOS or CCD image sensor used in an imaging application. In some examples, the sensor component 414 may further include an acceleration sensor, a gyroscope sensor, a magnetic sensor, a pressure sensor, or a temperature sensor.

The communication component 416 is configured to facilitate wired or wireless communication between the system 400 and other devices. The system 400 may access a wireless network based on a communication standard, such as WiFi, 4G, or a combination thereof. In an example, the communication component 416 receives a broadcast signal or broadcast related information from an external broadcast management system via a broadcast channel. In an example, the communication component 416 may further include a Near Field Communication (NFC) module for promoting short-range communication. For example, the NFC module may be implemented based on Radio Frequency Identification (RFID) technology, infrared data association (IrDA) technology, Ultra-Wide Band (UWB) technology, Bluetooth (BT) technology and other technology.

In an example, the system 400 may be implemented by one or more of Application Specific Integrated Circuits (ASIC), Digital Signal Processors (DSP), Digital Signal Processing Devices (DSPD), Programmable Logic Devices (PLD), Field Programmable Gate Arrays (FPGA), controllers, microcontrollers, microprocessors or other electronic elements to perform the above method.

A non-transitory computer readable storage medium may be, for example, a Hard Disk Drive (HDD), a Solid-State Drive (SSD), Flash memory, a Hybrid Drive or Solid-State Hybrid Drive (SSHD), a Read-Only Memory (ROM), a Compact Disc Read-Only Memory (CD-ROM), a magnetic tape, a floppy disk, and etc.

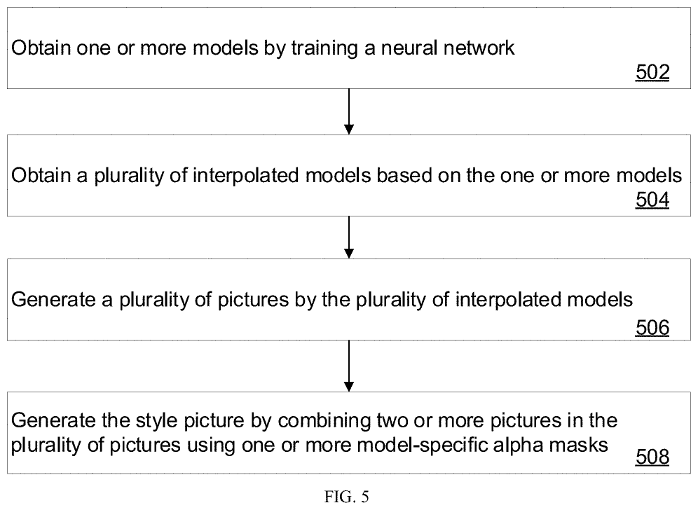

FIG. 5 is a flowchart illustrating an exemplary process of generating a style picture in accordance with some implementations of the present disclosure.

In step 502, the processor 420 obtains one or more models by training a neural network.

In some examples, the one or more models may have same architecture.

In some examples, the one or more models may include a base model obtained by training a neural network using a face dataset.

In some examples, the one or more models may include one or more transferred models obtained by training the base model using one or more new datasets.

In some examples, the one or more models may include multiple interpolated models obtained by respectively interpolating different layers of the base model or the one or more transferred models.

In some examples, the neural network is a StyleGAN. The face dataset may include fake human face photos generated by a neural network such as StyleGAN.

In step 504, the processor 420 obtains a plurality of interpolated models based on the one or more models obtained in the step 502.

In step 506, the processor 420 generates a plurality of pictures by the plurality of interpolated models.

In step 508, the processor 420 generates the style picture by combining two or more pictures in the plurality of pictures using one or more model-specific alpha masks.

In some examples, the plurality of interpolated models may include a first interpolated model and a second interpolated model.

In some examples, the processor 420 may further generate a first picture by the first interpolated model, generate a second picture by the second interpolated model, and generate the style picture by combining the first picture and the second picture using a first model-specific alpha mask in the one or more model-specific alpha masks.

In some examples, the processor 420 may further identify a facial target area in the first picture and determining an intermediate matrix for the facial target area, obtain an alpha mask matrix by performing convolution operations on the intermediate matrix, and generate the style picture based on the alpha mask matrix, the first picture, and the second picture.

In some examples, each picture of a plurality of pictures generated by the first interpolated model may include the facial target area.

In some examples, the processor 420 may perform the convolution operations on the intermediate matrix by performing the convolution operations on the intermediate matrix by using a kernel function.

In some examples, the plurality of interpolated models may include a first interpolated model, a second interpolated model, and a third interpolated model. Further, the processor 420 may respectively generate a first picture, a second picture, and a third picture by the first interpolated model, the second interpolated model, and the third interpolated model, generate a first combined picture by combining the first picture and the second picture using a first model-specific alpha mask in the one or more model-specific alpha masks, and generate the style picture by combining the first combined picture and the third picture using a second model-specific alpha mask in the one or more model-specific alpha masks.

In some examples, the first model-specific alpha mask may be the same as or different from the second model-specific alpha mask.

In some examples, the processor 420 may further generate a plurality of transferred models in different training periods by training the base model on a dataset of a style and obtain the plurality of interpolated model based on the plurality of transferred models in the different training periods.

In some examples, the processor 420 may generate a plurality of different transferred models by training the base model on a plurality of datasets of different styles.

In some examples, the processor 420 may obtain a plurality of interpolated models by interpolating at different layers of a transferred model.

In some examples, there is provided an apparatus for generating a style picture. The apparatus includes one or more processors 420 and a memory 404 configured to store instructions executable by the one or more processors; where the processor, upon execution of the instructions, is configured to perform a method as illustrated in FIG. 5.

In some other examples, there is provided a non-transitory computer readable storage medium 404, having instructions stored therein. When the instructions are executed by one or more processors 420, the instructions cause the processor to perform a method as illustrated in FIG. 5.

The description of the present disclosure has been presented for purposes of illustration, and is not intended to be exhaustive or limited to the present disclosure. Many modifications, variations, and alternative implementations will be apparent to those of ordinary skill in the art having the benefit of the teachings presented in the foregoing descriptions and the associated drawings.

The examples were chosen and described in order to explain the principles of the disclosure, and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for generating a style picture, comprising:
obtaining one or more models by training a neural network;
obtaining a plurality of interpolated models based on the one or more models;
generating a plurality of pictures by the plurality of interpolated models; and
generating the style picture by combining two or more pictures in the plurality of pictures using one or more model-specific alpha masks.

2. The method of claim 1, wherein the plurality of interpolated models comprise a first interpolated model and a second interpolated model; and
wherein the method further comprises:
generating a first picture by the first interpolated model and generating a second picture by the second interpolated model; and
generating the style picture by combining the first picture and the second picture using a first model-specific alpha mask in the one or more model-specific alpha masks.

3. The method of claim 2, wherein generating the style picture by combining the first picture and the second picture using the first model-specific alpha mask comprises:
identifying a facial target area in the first picture and determining an intermediate matrix for the facial target area;
obtaining an alpha mask matrix by performing convolution operations on the intermediate matrix; and
generating the style picture based on the alpha mask matrix, the first picture, and the second picture.

4. The method of claim 3, wherein each picture of a plurality of pictures generated by the first interpolated model comprises the facial target area.

5. The method of claim 3, wherein performing the convolution operations on the intermediate matrix comprises:
performing the convolution operations on the intermediate matrix by using a kernel function.

6. The method of claim 1, wherein the plurality of interpolated models comprise a first interpolated model, a second interpolated model, and a third interpolated model; and
wherein the method further comprises:
respectively generating a first picture, a second picture, and a third picture by the first interpolated model, the second interpolated model, and the third interpolated model;
generating a first combined picture by combining the first picture and the second picture using a first model-specific alpha mask in the one or more model-specific alpha masks; and
generating the style picture by combining the first combined picture and the third picture using a second model-specific alpha mask in the one or more model-specific alpha masks.

7. The method of claim 1, further comprising:
obtaining a base model by training the neural network using a face dataset;
generating one or more transferred models by training the base model using one or more new datasets; and
obtaining the plurality of interpolated models based on at least one the base model or the one or more transferred models.

8. The method of claim 7, wherein generating the one or more transferred models by training the base model using the one or more new datasets comprises:
generating a plurality of different transferred models in different training periods by training the base model on a dataset of a style; or
generating the plurality of different transferred models by training the base model on a plurality of datasets of different styles.

9. The method of claim 1, wherein obtaining the plurality of interpolated models based on the one or more models comprises:
obtaining the plurality of interpolated models by interpolating at different layers in one of the one or more models.

10. The method of claim 1, wherein the neural network is a style-based generative adversarial network (GAN).

11. An apparatus for generating a style picture, comprising:
one or more processors; and
a memory configured to store instructions executable by the one or more processors; wherein the one or more processors, upon execution of the instructions, are configured to:
obtain one or more models by training a neural network;
obtain a plurality of interpolated models based on the one or more models;
generate a plurality of pictures by the plurality of interpolated models; and
generate the style picture by combining two or more pictures in the plurality of pictures using one or more model-specific alpha masks.

12. The apparatus of claim 11, wherein the plurality of interpolated models comprise a first interpolated model and a second interpolated model; and
wherein the one or more processors are further configured to:
generate a first picture by the first interpolated model and generating a second picture by the second interpolated model; and
generate the style picture by combining the first picture and the second picture using a first model-specific alpha mask in the one or more model-specific alpha masks.

13. The apparatus of claim 12, wherein the one or more processors are further configured to generate the style picture by combining the first picture and the second picture using the first model-specific alpha mask comprises that the one or more processors are further configured to:
identify a facial target area in the first picture and determining an intermediate matrix for the facial target area;
obtain an alpha mask matrix by performing convolution operations on the intermediate matrix; and
generate the style picture based on the alpha mask matrix, the first picture, and the second picture.

14. The apparatus of claim 13, wherein each picture of a plurality of pictures generated by the first interpolated model comprises the facial target area.

15. The apparatus of claim 11, wherein the plurality of interpolated models comprise a first interpolated model, a second interpolated model, and a third interpolated model; and
wherein the one or more processors are further configured to:
respectively generate a first picture, a second picture, and a third picture by the first interpolated model, the second interpolated model, and the third interpolated model;
generate a first combined picture by combining the first picture and the second picture using a first model-specific alpha mask in the one or more model-specific alpha masks; and
generate the style picture by combining the first combined picture and the third picture using a second model-specific alpha mask in the one or more model-specific alpha masks.

16. The apparatus of claim 11, wherein the one or more processors are further configured to:
obtaining a base model by training the neural network using a face dataset;
generating one or more transferred models by training the base model using one or more new datasets; and
obtaining the plurality of interpolated models based on at least one of the base model or the one or more transferred models.

17. A non-transitory computer readable storage medium, comprising instructions stored therein, wherein, upon execution of the instructions by one or more processors, the instructions cause the one or more processors to perform acts comprising:
obtaining one or more models by training a neural network;
obtaining a plurality of interpolated models based on the one or more models;
generating a plurality of pictures by the plurality of interpolated models; and
generating the style picture by combining two or more pictures in the plurality of pictures using one or more model-specific alpha masks.

18. The non-transitory computer readable storage medium of claim 17, wherein the plurality of interpolated models comprise a first interpolated model and a second interpolated model; and
wherein the instructions cause the one or more processors to perform acts further comprising:
generating a first picture by the first interpolated model and generating a second picture by the second interpolated model; and
generating the style picture by combining the first picture and the second picture using a first model-specific alpha mask in the one or more model-specific alpha masks.

19. The non-transitory computer readable storage medium of claim 18, wherein generating the style picture by combining the first picture and the second picture using the first model-specific alpha mask comprises:
identifying a facial target area in the first picture and determining an intermediate matrix for the facial target area;
obtaining an alpha mask matrix by performing convolution operations on the intermediate matrix; and
generating the style picture based on the alpha mask matrix, the first picture, and the second picture.

20. The non-transitory computer readable storage medium of claim 19, wherein each picture of a plurality of pictures generated by the first interpolated model comprises the facial target area.
